(19) United States
(12) Patent Application Publication
(10) Pub. No.: US 2020/0311684 A1
(43) Pub. Date: Oct. 1, 2020

(54) SKILLS-BASED TALENT PACKAGING

(71) Applicant: Microsoft Technology Licensing, LLC, Redmond, WA (US)

(72) Inventors: Rui Ma, Santa Clara, CA (US); Keheng Zhang, Belmont, CA (US); Yongqing Yuan, Mountain View, CA (US); Baolu Shen, Santa Clara, CA (US); Kefang Ning, Sunnyvale, CA (US)

(73) Assignee: Microsoft Technology Licensing, LLC, Redmond, WA (US)

(21) Appl. No.: 16/367,793

(22) Filed: Mar. 28, 2019

(51) Int. Cl. G06Q 10/10; G06Q 10/06

(52) U.S. Cl. CPC G06Q 10/1053; G06Q 10/063112

(57) ABSTRACT

The disclosed embodiments provide a system for processing data. During operation, the system identifies candidates for opportunities in a domain based on communication between the candidates and moderators of the opportunities. Next, the system determines a set of skills as representative of talent in the domain based on occurrences of the set of skills in attributes of the candidates. The system then identifies additional candidates with experience in the domain based on overlap between additional attributes of the additional candidates and the set of skills. Finally, the system outputs the additional candidates as recommendations to additional moderators of additional opportunities in the domain.

### BACKGROUND

### Field

The disclosed embodiments relate to techniques for performing skills-based talent packaging of candidates for opportunities.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of performing skills-based talent packaging in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing skills-based talent packaging. In these embodiments, talent packaging includes identifying and grouping candidates with attributes that are indicative of knowledge, experience, or expertise in a certain domain. For example, candidates with skills that are identified as important to recruiters for in-demand occupations such as artificial intelligence, big data, autonomous vehicles, computer vision, and/or natural language processing (NLP) may be aggregated into “talent packages” for those occupations. The talent packages may then be presented to moderators of jobs to allow the moderators to find candidates for jobs/opportunities and/or improve job-seeking for the candidates.

More specifically, the disclosed embodiments perform statistical analysis of candidate attributes to identify, for a given domain, a set of skills that is sought by moderators of opportunities in that domain. For example, communications (e.g., messages, emails, phone calls, etc.) from the moderators to candidates regarding opportunities in the domain may be used to identify the candidates as related to the domain and aggregate skill sets of the candidates. The skill sets are compared with skill sets from a general pool of candidates (e.g., candidates that were not specifically targeted by moderators for the opportunities) to identify skills that are overrepresented in the candidates, and scores for the identified skills are calculated based on the proportion and/or level of overrepresentation of the skills in the candidates.

Skills that are identified as indicative of talent in a given domain are then used to generate a “talent package” containing a pool of candidates for the domain. For example, candidates with more than a minimum number of skills identified as representative of the domain and/or skills with aggregated scores that exceed a threshold may be included in the pool. Candidates in the pool may optionally be validated using input from users with knowledge of the preferences and/or requirements of moderators of opportunities in the domain.

Candidates in the talent package may further be filtered and/or segmented to reflect a certain type of background and/or additional attributes desired by the moderators. For example, a talent package that is generated for moderators of jobs in a given country may include candidates that are located in the country, speak the primary language in the country, have current or previous positions in the country, and/or have current or previous education in the country. In another example, moderators may filter candidates in a talent package based on additional attributes such as years of experience, educational background, seniority, location, additional skills, and/or industry.

By using aggregated skills and/or other attributes to characterize talent and identify candidates with knowledge or experience in various domains, the disclosed embodiments allow the candidates to be matched with opportunities in the domains. In turn, the disclosed embodiments expedite moderators finding candidates for jobs/opportunities and/or job-seeking for candidates. In contrast, conventional techniques require moderators to manually search for candidates with attributes that potentially match requirements for the opportunities. Such manual searching of candidates is tedious, time-consuming, and/or error-prone, resulting in suboptimal user experiences for both the moderators and candidates contacted by the moderators. Further, when moderators manually search, they may not know how to formulate the query (e.g., what skills to search for) to find candidates they are interested in. Thus, by manually searching for candidates, moderators may fail to find candidates of interest or may perform multiple queries over an extended period of time to find the candidates of interest. Consequently, the disclosed embodiments may improve computer systems, applications, user experiences, tools, and/or technologies related to user recommendations, employment, recruiting, and/or hiring.

### Skills-Based Talent Packaging

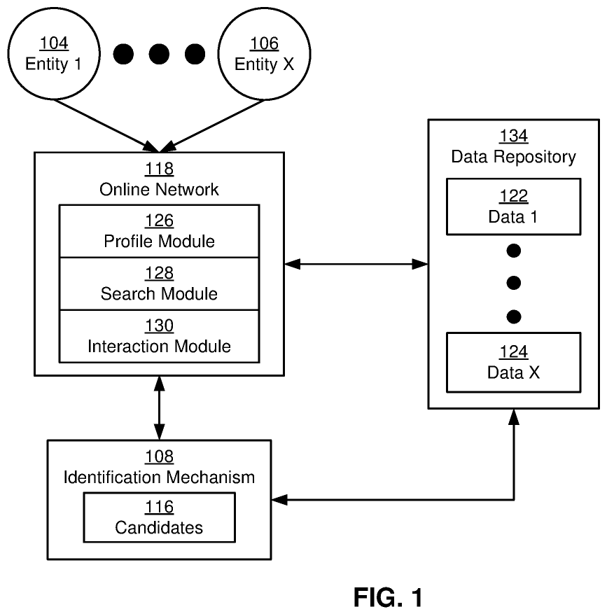

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strengths of candidates 116 with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, patents, publications, reputation scores, etc.). The rankings may then be generated by ordering candidates 116 by descending score.

In turn, rankings based on the scores and/or associated insights may improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

In one or more embodiments, online network 118 includes functionality to perform skills-based talent packaging of candidates 116 for opportunities. For example, online network 118 may identify skills that are important to moderators of jobs in a certain domain. Online network 118 may create a “talent package” containing candidates 116 with knowledge, experience, and/or expertise in the domain based on the presence of the identified skills in the candidates' profiles. Online network 118 may additionally output the talent package to the moderators to reduce overhead associated with manually searching for candidates 116 that fit the requirements or qualifications of the jobs.

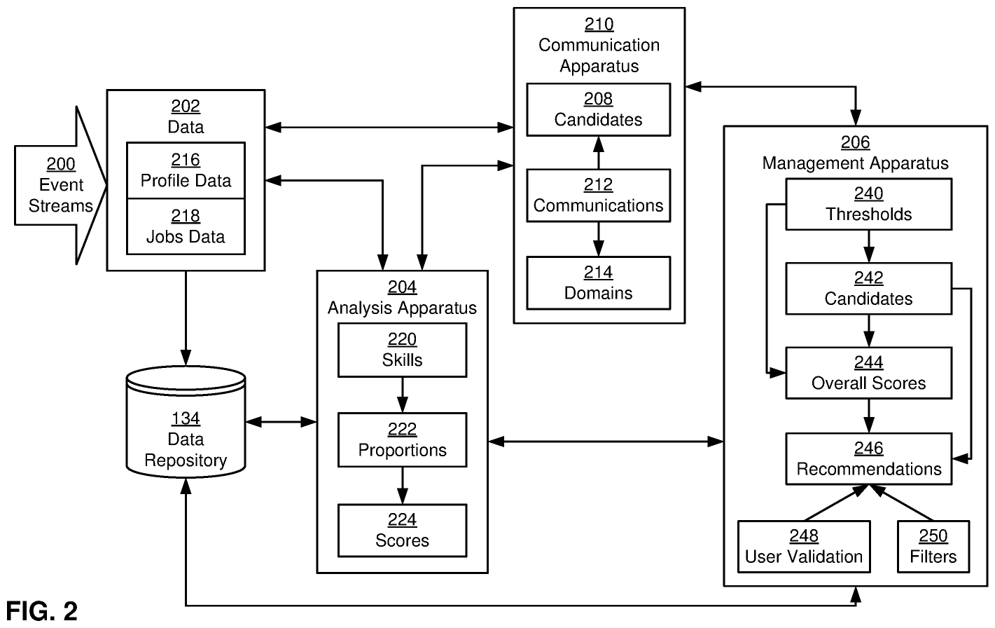

As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network. Profile data 216 includes data associated with member profiles in the online network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online network.

Attributes of the members from profile data 216 may be matched to a number of member segments, with each member segment containing a group of members that share one or more common attributes. For example, member segments in the online network may be defined to include members with the same industry, title, seniority, function, degree, field of study, location, and/or language.

Connection information in profile data 216 may additionally be combined into a graph, with nodes in the graph representing entities (e.g., users, schools, companies, locations, etc.) in the online network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online network. For example, jobs data 218 for a given job or job listing may include a declared or inferred title, company, required or desired skills, responsibilities, qualifications, role, location, industry, seniority, salary range, benefits, education level, and/or member segment.

In one or more embodiments, data repository 134 stores data 202 that represents standardized, organized, and/or classified attributes. For example, skills in profile data 216 and/or jobs data 218 may be organized into a hierarchical taxonomy that is stored in data repository 134. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the community may be generated in response to the activity. The record may then be propagated to components subscribing to event streams 200 on a nearline basis.

As mentioned above, the system of FIG. 2 includes functionality to identify skills 220 that are relevant to or indicative of talent in one or more domains 214. For example, the system may be used to identify sets of skills 220 that represent knowledge, experience, and/or expertise in high-demand domains 214 such as artificial intelligence, big data, deep learning, computer vision, robotics, NLP, autonomous vehicles, computer vision, healthcare, senior management, and/or executives.

A communication apparatus 210 manages and/or tracks communications 212 between moderators of opportunities related to domains 214 and a set of candidates 208. For example, communication apparatus 210 may include and/or form a part of a platform that allows the moderators to exchange and/or conduct emails, chat messages, phone calls, voicemails, video calls, teleconferences, social media messages, Short Message Service (SMS) messages, meeting invitations, and/or other types of communications 212 with candidates 208 for opportunities managed by the moderators.

In one or more embodiments, communication apparatus 210 identifies a subset of communications 212 as related to domains 214. For example, communication apparatus 210 may obtain job requisitions, hiring projects, and/or other types of identifiers for jobs from metadata related to communications 210 sent by moderators of the jobs (e.g., from accounts of the moderators with the online network and/or a recruiting tool). Communication apparatus 210 may use the identifiers to retrieve titles, industries, functions, descriptions, requirements, categories, and/or other attributes in jobs data 218 for the jobs and match the attributes to key words or phrases associated with domains 214. In another example, communication apparatus 210 may analyze the content of communications 210 to categorize individual messages and/or threads of conversation between moderator-candidate pairs as relevant or not relevant to one or more domains 214. In a third example, communication apparatus 210 may match changes to current jobs in profile data 216 for candidates 208 to communications 212 between candidates 208 and moderators of the jobs.

An analysis apparatus 204 uses candidates 208 identified by communication apparatus 210 as recipients of communications 212 related to domains 214 to determine skills 220 that are representative of talent in domains 214. In one or more embodiments, skills 220 are identified based on comparisons of proportions 222 of skills 220 in candidates 208 with proportions 222 of skills 220 in a general pool of candidates. Proportions 222 are then used to calculate scores 224 that indicate the importance of skills 220 to moderators for opportunities in domains 214.

For example, analysis apparatus 204 may obtain skills 220 that are listed in profile data 216 of candidates 208 that have been contacted by recruiters for jobs in a given domain (e.g., domains 214). For each of the skills, analysis apparatus 204 may calculate a first proportion of the skill in candidates 208 and a second proportion of the skill in a general candidate pool (e.g., candidates from industries related to domains 214). Analysis apparatus 204 may divide the first proportion by the second proportion to obtain a ratio representing the level of overrepresentation of the skill in candidates 208 compared with the general candidate pool. Analysis apparatus 204 may then combine, for each skill, the ratio and the first proportion into a score (e.g., scores 224) for the skill (e.g., by summing the ratio and first proportion). Analysis apparatus 204 may optionally normalize the ratio and first proportion prior to calculating the score to adjust the contributions of the ratio and first proportion to the value of the score (e.g., so that the contribution of the ratio to the score is roughly double the contribution of the first proportion to the score).

Consequently, scores 224 may represent measures of importance of the corresponding skills in identifying and/or placing qualified candidates 208 for opportunities in domains 214. Continuing with the above example, a high score for a skill may indicate a high proportion of the skill in candidates 208 contacted by moderators of opportunities in a domain and/or an overrepresentation of the skill in candidates 208, while a lower score may indicate a lower proportion of the skill in candidates 208 and/or a lack of overrepresentation of the skill in candidates 208.

A management apparatus 206 uses scores 224 for skills 220 and profile data 216 in data repository 134 to identify additional candidates 242 with experience in domains 214 and generate recommendations 246 related to the identified candidates 242 and opportunities in domains 214. In one or more embodiments, candidates 242 with experience in a given domain are identified based on overlap between skills 220 identified by analysis apparatus 204 as important to moderators of opportunities in the domain and skills listed in profile data of candidates 242. For example, management apparatus 206 may obtain, from analysis apparatus 204 and/or another component, a list containing a pre-specified number of skills 220 with the highest scores 224 for the domain and/or a variable number of skills 220 with scores 224 that exceed a numeric threshold. Management apparatus 206 may query data repository 134 and/or another data source for candidates 242 with profile data 216 that lists at least three of the identified skills 220. Management apparatus 206 may then populate a “talent package” for the domain with the identified candidates 242, store associations of candidates 242 with the talent package in data repository 134, and/or output a representation of the talent package and/or candidates 242 in the talent package as recommendations 246 to moderators of opportunities in the domain. Management apparatus 206 may also, or instead, output recommendations 246 of opportunities in the domain to candidates 242 in the talent package.

In one or more embodiments, management apparatus 206 uses skills 220 listed in profile data 216 for candidates 242 to calculate overall scores 244 for candidates 242 and generates recommendations 246 based on comparisons of overall scores 244 with one or more thresholds 240. Continuing with the above example, management apparatus 206 may obtain a set of candidates 242 that possess at least three skills 220 that are important to moderators of opportunities in a domain. For each of the candidates, management apparatus 206 may aggregate (e.g., sum, average, etc.) scores 224 for skills 220 possessed by the candidate into an overall score for the candidate. Management apparatus 206 may then apply a threshold to overall scores 244 for all candidates 242 to identify a subset of candidates 242 with the highest overall scores 244 for inclusion in the talent package.

Management apparatus 206 optionally generates and/or updates recommendations 246 based on user validation 248 of candidates 242 and/or skills 220. For example, management apparatus 206 may provide a user interface that displays profile data 216 for candidates 242 to a number of users with knowledge of the requirements and/or preferences of moderators of opportunities in the corresponding domain. The users may provide input through the user interface to specify if a given candidate is a good fit or not a good fit for opportunities in the domain. After a candidate is validated by a user to be a good fit for opportunities in the domain, management apparatus 206 may include the candidate in the talent package for the domain and/or additional recommendations 246 related to opportunities in the domain.

In another example, management apparatus 206 may output a list of skills 220 identified as important or relevant to a domain by analysis apparatus 204, along with scores 224 that characterize the importance of skills 220 to the domain. A user may review the outputted list, confirm the relevance of a skill in the list to the domain, and/or remove a skill that is considered irrelevant to the domain from the list. The user may also, or instead, group subsets of skills 220 in the list under additional domains 214 that are related to the domain (e.g., domains 214 of computer vision, deep learning, and natural language processing that are related to a broader artificial intelligence domain).

To customize recommendations 246 to the needs or preferences of individual moderators, management apparatus 206 also includes functionality to apply filters 250 to candidates 242 and/or recommendations 246 related to opportunities in domains 214. For example, management apparatus 206 may generate a talent package for opportunities in a domain that are located in a given country. To tailor candidates 242 to moderators of the opportunities, management apparatus 206 may limit recommendations 246 to candidates 242 with profile data 216 that indicates a reasonable proficiency in the country's language, a current residence in the country, a current job in the country, a previous job in the country, a current education in the country, and/or a previous education in the country.

In another example, management apparatus 206 may apply custom filters specified by the moderators to recommendations 246. Such filters may include, but are not limited to, years of experience in a skill; title, seniority, function, industry, and/or additional skills; school, degree, and/or other educational background; location, language, and/or another demographic attribute; and/or awards, publications, certifications, and/or licenses.

In a third example, management apparatus 206 may improve the relevance and/or accuracy of recommendations 246 by filtering candidates 242 by one or more attributes in profile data 216 prior to including candidates 242 in recommendations 246. Continuing with the example, management apparatus 206 may restrict candidates 242 in an artificial intelligence domain to technology, finance, and research functions to prevent human resources and/or business development professionals that list some of the same skills as artificial intelligence practitioners or experts from being included in recommendations 246 for the domain. Management apparatus 206 may also, or instead, perform impression discounting that decreases a candidate's position in a list of recommendations 246 to a moderator as the recruiter's views of the candidate increase. Management apparatus 206 may also, or instead, adjust a candidate's position in a list of recommendations 246 for a domain to reflect the candidate's activeness in job seeking within or outside the domain.

Management apparatus 206 and/or another component may additionally track responses to recommendations 246 and update skills 220, scores 224, thresholds 240, candidates 242, overall scores 244, and/or recommendations 246 based on the responses. For example, the component may detect messages and/or other communications 212 between moderators and one or more candidates 242 outputted as recommendations 246 for a given domain to the moderators and update skills 220 and/or scores 224 based on profile data 216 for the candidate(s). The updated skills 220 and/or scores 224 may be then be used to revise the set of candidates 242 from which recommendations 246 in the domain are generated. In another example, one or more moderators may respond to a recommendation of a candidate in a talent package for a domain with an indication that the candidate is not relevant to the domain, and the component may update skills 220, scores 224, thresholds 240, candidates 242, overall scores 244, and/or recommendations 246 associated with the domain to reflect the indication.

By using aggregated skills and/or other attributes to characterize talent and identify candidates with knowledge or experience in various domains, the system of FIG. 2 allows the candidates to be matched with opportunities in the domains. In turn, the system may expedite job seeking by the candidates and/or placement of jobs or opportunities by moderators of the opportunities. In contrast, conventional techniques may require moderators to manually search for candidates with attributes that potentially match requirements for the opportunities. Such manual searching of candidates may be tedious, time-consuming, and/or error-prone, resulting in suboptimal user experiences for both the moderators and candidates contacted by the moderators. Consequently, the disclosed embodiments may improve computer systems, applications, user experiences, tools, and/or technologies related to user recommendations, employment, recruiting, and/or hiring.

Those skilled in the art will appreciate that the system of FIG. 2 may be implemented in a variety of ways. First, analysis apparatus 204, communication apparatus 210, management apparatus 206, and data repository 134 may be provided by a single physical machine, multiple computer systems, one or more virtual machines, a grid, one or more databases, one or more filesystems, and/or a cloud computing system. Analysis apparatus 204, communication apparatus 210, and management apparatus 206 may additionally be implemented together and/or separately by one or more hardware and/or software components and/or layers.

Second, the system of FIG. 2 may be adapted to various types of opportunities and/or candidates. For example, the functionality of the system may be used to identify qualified candidates for various types of academic positions, artistic or musical roles, school admissions, fellowships, scholarships, competitions, club or group memberships, matchmaking, collaborations, mentorships, and/or other types of opportunities.

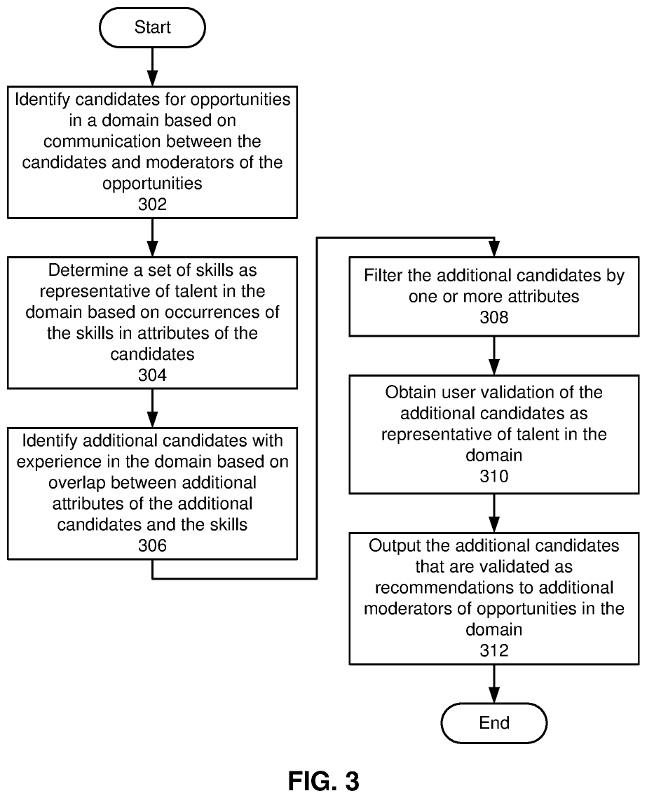

FIG. 3 shows a flowchart illustrating a process of performing skills-based talent packaging in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, candidates for opportunities in a domain are identified based on communication between the candidates and moderators of the opportunities (operation 302). For example, the candidates may be identified as recipients of messages, emails, phone calls, voicemails, meeting invitations, and/or other types of communications from the moderators for the purposes of hiring for or placing jobs in the domain.

Next, a set of skills is determined as representative of talent in the domain based on occurrences of the skills in attributes of the candidates (operation 304). For example, skills found in attributes of the candidates may be obtained, and a score for each skill may be calculated based on a first proportion of the skill in attributes of the candidates and a second proportion of the skill in a general candidate pool (e.g., candidates in the industry to which the domain belongs). The score may include a first component that represents a ratio of the first proportion to the second proportion and a second component that represents the first proportion. The components of the score may be normalized to adjust the contribution of each component to the score. A threshold may then be applied to scores for the skills to identify a certain number of highest-scoring skills and/or a variable number of skills with scores that exceed a numeric value as important to moderators of opportunities in the domain.

Additional candidates with experience in the domain are identified based on overlap between additional attributes of the additional candidates and the skills (operation 306). For example, a candidate may be identified as having experience in the domain when the candidate has at least three skills identified in operation 304 as representative of talent in the domain In another example, scores for skills identified as representative of talent in the domain and that are also possessed by the candidate may be aggregated into an overall score for the candidate, and a threshold may be applied to the overall score to determine whether or not the candidate's skills are sufficient to deem the candidate as experienced in the domain.

The additional candidates are filtered by one or more attributes (operation 308). For example, the additional candidates may be limited to a language, current location, current job location, previous job location, current education location, and/or previous education location for a given country and/or region. In another example, the additional candidates may be filtered to have a certain level of experience, educational background, industry, function, seniority, and/or other attribute.

User validation of the additional candidates as representative of talent in the domain is additionally obtained (operation 310). For example, the additional candidates may be included in a pool of potential recommendations that is displayed to one or more users with knowledge of the requirements and/or preferences of moderators of opportunities in the domain. After the user(s) validate a given candidate as a good fit for the domain, the candidate may be moved to a “talent package” for the domain.

Finally, the additional candidates that are validated are outputted as recommendations to additional moderators of the opportunities or of additional opportunities in the domain (operation 312). Continuing with the above example, candidates in the talent package may be outputted as recommendations to the moderators to assist the moderators with finding qualified applicants for jobs in the domain.

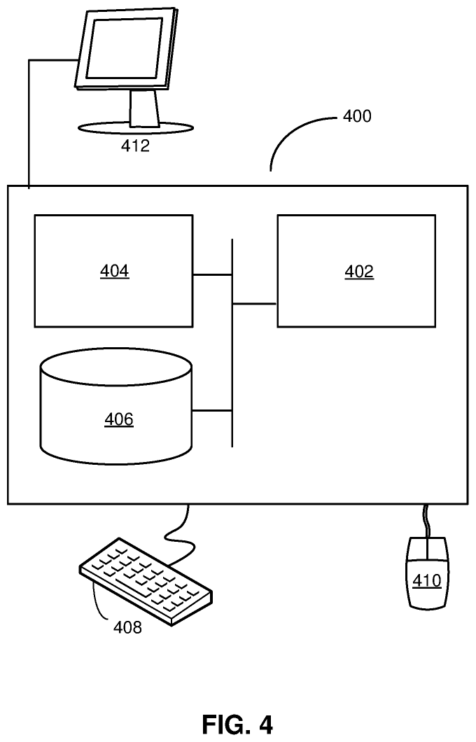

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for a user (e.g., a candidate and/or moderator for an opportunity). To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a communication apparatus, an analysis apparatus, and a management apparatus, one or more of which may alternatively be termed or implemented as a module, mechanism, or other type of system component. The communication apparatus identifies candidates for opportunities in a domain based on communication between the candidates and moderators of the opportunities. The analysis apparatus determines a set of skills as representative of talent in the domain based on occurrences of the set of skills in attributes of the candidates. The analysis apparatus also identifies additional candidates with experience in the domain based on overlap between additional attributes of the additional candidates and the set of skills. The management apparatus outputs the additional candidates as recommendations to additional moderators of additional opportunities in the domain

In addition, one or more components of computer system 400 may be remotely located and connected to the other components over a network. Portions of the present embodiments (e.g., analysis apparatus, communication apparatus, management apparatus, data repository, online network, etc.) may also be located on different nodes of a distributed system that implements the embodiments. For example, the present embodiments may be implemented using a cloud computing system that generates and/or customizes talent packages for a set of remote job moderators.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
identifying candidates for opportunities in a domain based on communication between the candidates and moderators of the opportunities;
determining, by one or more computer systems, a set of skills as representative of talent in the domain based on occurrences of the set of skills in attributes of the candidates;
identifying, by the one or more computer systems, additional candidates with experience in the domain based on overlap between additional attributes of the additional candidates and the set of skills; and
outputting the additional candidates as recommendations to additional moderators of additional opportunities in the domain.

2. The method of claim 1, further comprising:
filtering the additional candidates by one or more of the additional attributes prior to outputting the additional candidates as the recommendations.

3. The method of claim 2, wherein the one or more of the additional attributes comprise at least one of:
a language;
a location of a candidate;
a current job location;
a previous job location;
a current education location; and
a previous education location.

4. The method of claim 2, wherein the one or more of the additional attributes comprise at least one of:
a level of experience;
an educational background;
an industry;
a function; and
a seniority.

5. The method of claim 1, further comprising:
obtaining user validation of the additional candidates as representative of talent in the domain prior to outputting the additional candidates as the recommendations.

6. The method of claim 1, wherein determining the set of skills as representative of talent in the domain based on occurrences of the set of skills in the attributes of the candidates comprises:
calculating a score for a skill based on a first proportion of the skill in the attributes of the candidates and a second proportion of the skill in a general candidate pool; and
including the skill in the set of skills based on a comparison of the score with a threshold.

7. The method of claim 6, wherein calculating the score for the skill based on the first proportion of the skill in the attributes of the candidates and the second proportion of the skill in the general candidate pool comprises:
calculating a first component of the score based on a ratio of the first proportion to the second proportion;
calculating a second component of the score based on the first proportion; and
combining the first and second components into the score.

8. The method of claim 6, wherein identifying the additional candidates with experience in the domain based on overlap between the additional attributes of the additional candidates and the set of skills comprises:
aggregating scores for a subset of the skills found in a set of attributes for a candidate into an overall score for the candidate; and
including the candidate in the additional candidates based on a comparison of the overall score with a threshold.

9. The method of claim 1, wherein identifying the additional candidates with experience in the domain based on overlap between the additional attributes of the additional candidates and the set of skills comprises:
including a candidate in the additional candidates based on a count of a subset of the skills found in a set of attributes for the candidate.

10. The method of claim 1, wherein identifying the additional candidates with experience in the domain based on overlap between the additional attributes of the additional candidates and the set of skills comprises:
obtaining the additional attributes from profiles of the additional candidates with an online network.

11. The method of claim 1, wherein the domain comprises at least one of:
artificial intelligence;
big data;
autonomous vehicles;
natural language processing; and
computer vision.

12. A system, comprising:
one or more processors; and
memory storing instructions that, when executed by the one or more processors, cause the system to:
identify candidates for opportunities in a domain based on communication between the candidates and moderators of the opportunities;
determine a set of skills as representative of talent in the domain based on occurrences of the set of skills in attributes of the candidates;
identify additional candidates with experience in the domain based on overlap between additional attributes of the additional candidates and the set of skills; and
output the additional candidates as recommendations to additional moderators of additional opportunities in the domain.

13. The system of claim 12, wherein the memory further stores instructions that, when executed by the one or more processors, cause the system to:
filter the additional candidates by one or more of the additional attributes prior to outputting the additional candidates as the recommendations.

14. The system of claim 13, wherein the one or more of the additional attributes comprise at least one of:
a language;
a location of a candidate;
a current job location;
a previous job location;
a current education location; and
a previous education location.

15. The system of claim 13, wherein the one or more of the additional attributes comprise at least one of:
a level of experience;
an educational background;
an industry;
a function; and
a seniority.

16. The system of claim 12, wherein determining the set of skills as representative of talent in the domain based on occurrences of the set of skills in the attributes of the candidates comprises:
calculating a score for a skill based on a first proportion of the skill in the attributes of the candidates and a second proportion of the skill in a general candidate pool; and
including the skill in the set of skills based on a comparison of the score with a threshold.

17. The system of claim 16, wherein identifying the additional candidates with experience in the domain based on overlap between the additional attributes of the additional candidates and the set of skills comprises:
aggregating scores for a subset of the skills found in a set of attributes for a candidate into an overall score for the candidate; and
including the candidate in the additional candidates based on a comparison of the overall score with a threshold and a count of the subset of the skills.

18. The system of claim 12, wherein the domain comprises at least one of:
artificial intelligence;
big data;
autonomous vehicles;
natural language processing; and
computer vision.

19. A non-transitory computer-readable storage medium storing instructions that when executed by a computer cause the computer to perform a method, the method comprising:
identifying candidates for opportunities in a domain based on communication between the candidates and moderators of the opportunities;
determining a set of skills as representative of talent in the domain based on occurrences of the set of skills in attributes of the candidates;
identifying additional candidates with experience in the domain based on overlap between additional attributes of the additional candidates and the set of skills; and
outputting the additional candidates as recommendations to additional moderators of additional opportunities in the domain.

20. The non-transitory computer-readable storage medium of claim 19, the method further comprising:
filtering the additional candidates by one or more of the additional attributes prior to outputting the additional candidates as the recommendations.
